(19) United States
(12) Patent Application Publication
(10) Pub. No.: US 2014/0338129 A1
(43) Pub. Date: Nov. 20, 2014

(54) BED WITH USER-ASSIST MECHANISM

(71) Applicant: Magna Closures Inc., Newmarket (CA)

(72) Inventors: John Robert Scott Mitchell, Newmarket (CA); Dikran Ghorghorian, Scarborough (CA); Gabriele Wayne Sabatini, Keswick (CA); Traian Miu, Oakville (CA)

(21) Appl. No.: 14/447,963

(22) Filed: Jul. 31, 2014

Related U.S. Application Data
(63) Continuation of application No. PCT/CA2013/000127, filed on Feb. 14, 2013.
(60) Provisional application No. 61/598,579, filed on Feb. 14, 2012.

(30) Foreign Application Priority Data
Feb. 14, 2013 (CA) PCT/CA2013/000127

(51) Int. Cl. A61G 7/053; A47C 17/86; A61G 7/018; A61G 7/005

(52) U.S. Cl. CPC A61G 7/053; A61G 7/005; A47C 17/86; A61G 7/018
USPC 5/610

(57) ABSTRACT

A bed, comprising: a user support structure including a body support member having a head region and a foot region, and a foot support member positioned proximate the foot region of the body support member and projecting laterally from the body support member; a frame for supporting the user support structure on a support surface; a coupling mechanism coupling the user support structure to the frame and providing for relative movement there-between; and an actuator that is configured to move the user support structure relative to the frame between a user rest position and a user reception/departure position, such that when in the user rest position the body support member is oriented to support the body of a user lying at least indirectly thereon, and when in the user reception/departure position, the body support member is oriented laterally to the foot support member such that the foot support member is oriented to support the user standing thereon.

### FIELD

The present invention relates to beds that are adjustable in position and more particularly to a bed with a mechanism to assist entry and exit from the bed.

### BACKGROUND

A wide assortment of adjustable beds are known. These adjustable beds are adaptable to change into a number of comfortable user selectable positions. Adjustable beds are used in hospitals, rehabilitation centers and for home applications. A common problem with both fixed position and adjustable position type beds is that it can be very difficult for bed users who have undergone major surgeries (including leg surgery and other back and limb surgeries) to get into and out of their bed comfortably.

However, current adjustable bed designs do not provide for ease of user ingress and egress from the bed without significant assistance by a care giver of the bed user. Further, sensor arrangements to inhibit accidental falls by the patient during ingress or egress can be unsuitable for bed user control of the bed position adjustment.

### SUMMARY

It is an object of the present invention to provide a bed having a user support structure configured to obviate or mitigate at least one of the above-presented disadvantages.

One aspect provided is a bed, comprising: a user support structure including a body support member having a head region and a foot region, and a foot support member positioned proximate the foot region of the body support member and projecting laterally from the body support member; a frame for supporting the user support structure on a support surface; a coupling mechanism coupling the user support structure to the frame and providing for relative movement there-between; and an actuator that is configured to move the user support structure relative to the frame between a user rest position and a user reception/departure position, such that when in the user rest position the body support member is oriented to support the body of a user lying at least indirectly thereon, and when in the user reception/departure position, the body support member is oriented laterally to the foot support member such that the foot support member is oriented to support the user standing thereon.

### BRIEF DESCRIPTION OF THE DRAWINGS

The foregoing and other aspects will be more readily appreciated having reference to the drawings, wherein:

FIG. 1 is a perspective view of a bed assembly;

FIGS. 2a,2b,2c,2d are operational examples of the bed assembly of FIG. 1;

FIG. 3 is a perspective view of a coupling mechanism to provide for operation of the bed assembly of FIG. 1; and

FIG. 4 is a further embodiment of the bed assembly of FIG. 1;

### DETAILED DESCRIPTION OF THE PREFERRED EMBODIMENTS

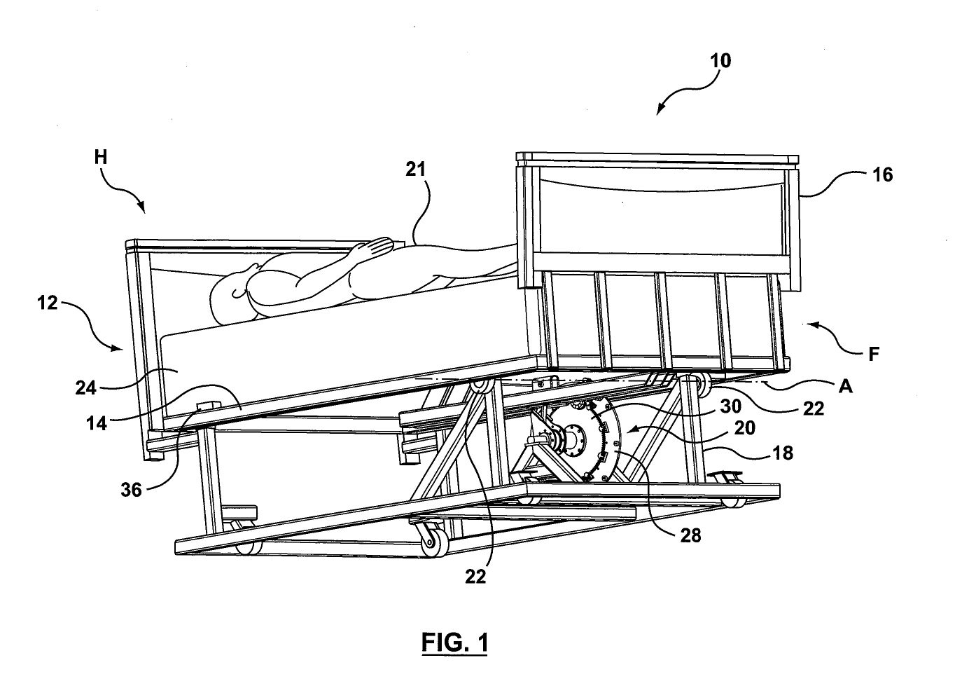

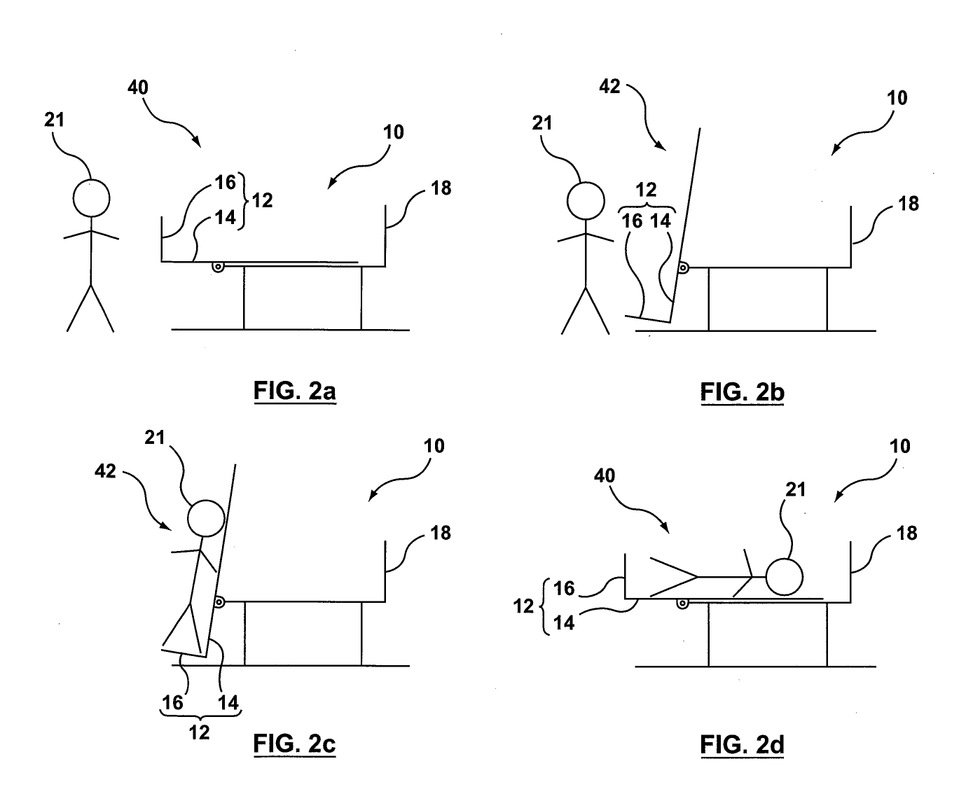

Reference is made to FIG. 1, which shows a bed 10 having a head region H and a foot region F configured for receiving and supporting a body of a person. The bed 10 includes a user support structure 12 that includes a body support member 14 extending between the head region H and foot region F and a foot support member 16 located proximate to the foot region F, a frame 18 for supporting the user support structure 12 with respect to an adjacent support surface (e.g. floor or wall in the case of a Murphy bed—not shown), and a coupling mechanism 22 for coupling the user support structure 12 to the frame 18 and providing for pivotal and/or translational movement of the user support structure 12 with respect to the frame 18. As such, the coupling mechanism 22 provides for movement of the user support structure 12 between a first position 40 (see FIGS. 2a and 2d) and a second position 42 (see FIGS. 2b and 2c), whereby an actuator 20 (e.g. mounted to the frame 18) positions the user support structure 12 between the first position 40 (otherwise known as a user rest position 40) shown in FIGS. 2a and 2d, and the second position 42 (otherwise known as a user reception/departure position 42) shown in FIGS. 2b and 2c. Movement of the user support structure 12 to these positions 40,42 permits the bed 10 to be used more easily by persons who have trouble sitting down or climbing into a traditional bed, and/or who have trouble getting up from a lying-down position. A person (which can also be referred to as a user) is shown positioned in the bed 10 at 21. The frame 18 can be made from a plurality of support members (e.g. tubular metal members), as shown and can optionally include wheels to facilitate relocation of the bed 10 as desired.

The user support structure 12 can be made from a combination of members and wood panels, as shown, and is movably supported on the frame 18 as provided by the coupling mechanism 22. In the embodiment shown, the user support structure 12 is pivotally supported at pivots as the coupling mechanism 22 for pivoting movement about pivot axis A between the user rest and user reception/departure positions 40,42.

As noted above, the user support structure 12 includes the body support member 14 and the foot support member 16. The body support member 14 can be configured to receive a removable or replaceable mattress 24 thereon. Preferably, the mattress 24 is fixedly connected to the body support member 14 so that the mattress 24 is restrained from tipping forwards when the body support member 14 is tilted generally vertically (i.e. when the user support structure 12 is in the user reception/departure position 42). The foot support member 16 can be fixedly connected to the body support member 14 at a foot region of the body support member 14, and can extend at an angle (e.g. generally perpendicularly) thereto to provide for placement and support of the user's feet. When the user support structure 12 is in the user rest position 42 (FIGS. 2a and 2d), the body support member 14 can be oriented generally horizontally so as to support the body of the user lying thereon at least indirectly (i.e. via the mattress 24), and the foot support member 16 can be oriented generally vertically to function as a footboard for the bed 10. When the user support structure 12 is in the user reception/departure position 42 (FIGS. 2b and 2c), the body support member 14 can be oriented generally vertically and the foot support member 16 can be oriented generally horizontally so as to support a user standing thereon.

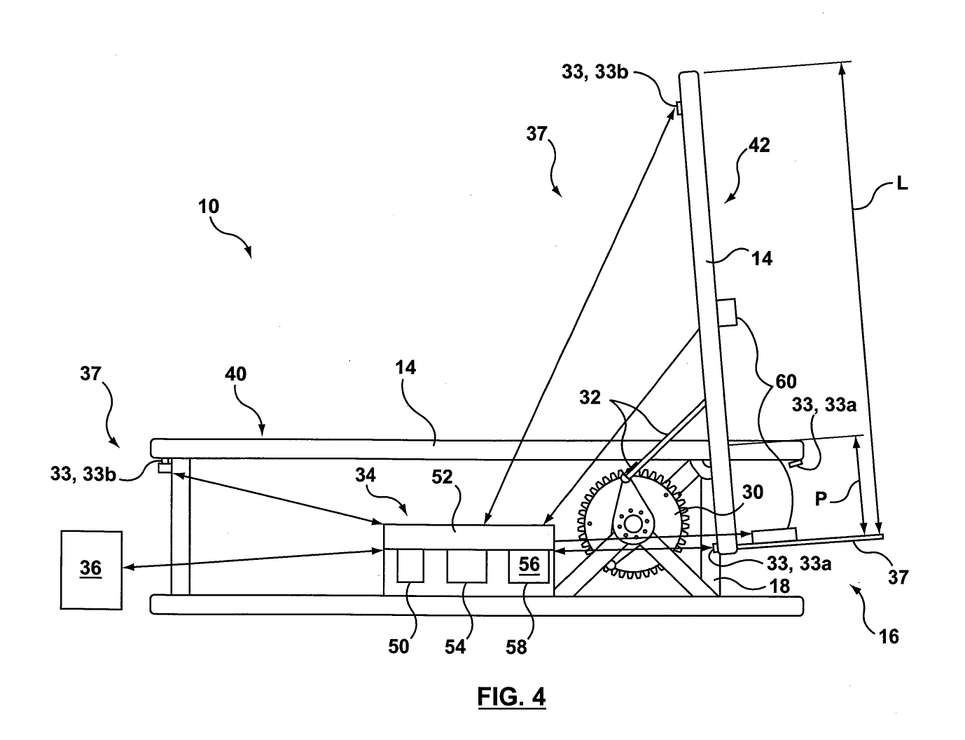

In this position the foot support member 16 is preferably positioned relatively close to the ground so that there is a relatively small step required by the user to step onto or off of the foot support member 16. In this manner, support members of the bed frame 18 adjacent to the coupling mechanism 22 are positioned away from a proximal end of the user support structure 12 having the foot support member 16, so as to provide for positioning of the foot support member 16 adjacent to the floor when the user support structure 12 is positioned in the user reception/departure position 42. Further, when positioned in the user reception/departure position 42, a portion P of a length L of the user support structure 12 (between the head of the bed and the foot of the bed) extends from the coupling mechanism 22 towards the floor to facilitate positioning of the foot support member 16 adjacent to the floor (see FIG. 4). It will be noted that, when the user support structure 12 is in the user reception/departure position 42, the foot support member 16 supports the user standing thereon, but the body support member 14 is itself is also positioned to be of assistance to the user, who can brace themselves with it when stepping onto or off of the foot support member 16.

For example, the coupling mechanism 22 can be configured to orient the user support structure 12 at a non-perpendicular angle with respect to the floor when the user support structure 12 is in the user reception/departure position 42, so as to provide for both the body support member 14 and the foot support member 16 to support a portion of the weight of the user. This non-perpendicular angle can be advantageous so as to inhibit the user from losing their balance and falling forward before they take their feet off of the foot support member 16 when climbing out of the bed 10, as well as to inhibit the user from losing their balance and falling forward after they take their feet off of the foot support member 16 when climbing into the bed 10 and before the user support structure 12 is lowered into the user rest position 40 via operation of the actuator 20.

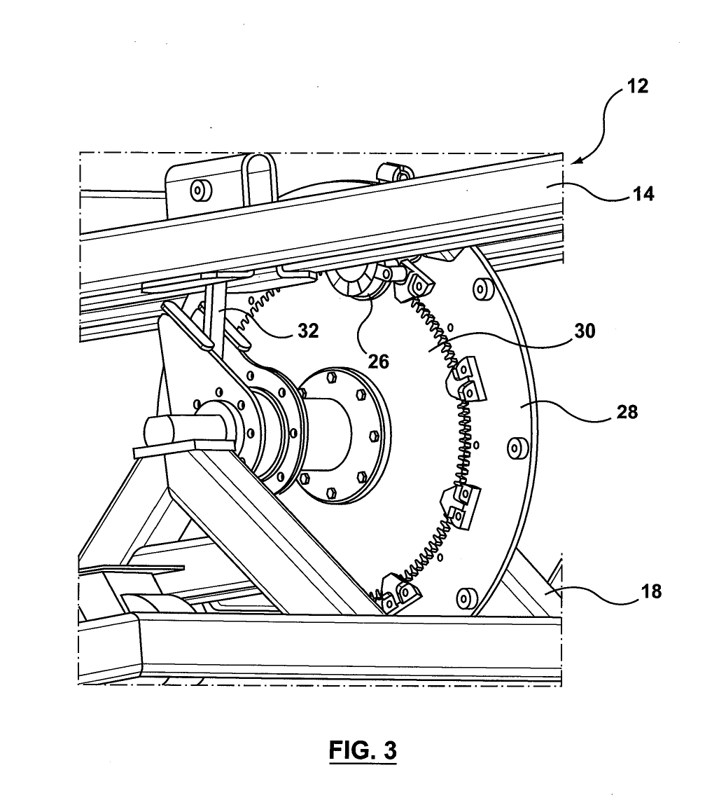

The actuator 20 is configured to move the user support structure 12 to the user rest 40 and user reception/departure 42 positions. The actuator 20 can include any suitable actuation mechanism to provide for power assisted movement of the user support structure 12 and optionally to provide for retention of the user support structure 12 when in the user rest position 40, the user reception/departure position 42, and/or temporarily in position when between the user rest position 40 and the user reception/departure position 42. In the embodiment shown, the actuator 20 includes an electric motor 26 that is supported on a support plate 28 on the frame 18, a final output gear 30 that is driven by the motor 26 (via one or more gears that are not shown), and a crank arm 32 that is pivotally connected between the output gear 30 and the user support structure 12. If desired, a plurality of small electric motors 26 can be mounted about the periphery of the final output gear 30 for driving the final output gear 30 in parallel. As best seen in FIG. 3, mounting means for eight electric motors 26 are provided so that eight electric motors 26 can be used to drive the output gear 30. Seven of the motors 26 are not shown in this figure however, so as not to obscure the final output gear 30.

The configuration of the one or more motors 26 and gears including the gear 30 can be selected such that the one or more motors 26 can drive the gears but the one or more motors 26 cannot be back-driven by the gears, thereby providing the position retention aspect of the user support structure 12 by the actuator 20. As a result, in the event of a power failure while the user support structure 12 is in a raised or partially raised position, it cannot fall down to the user rest position.

FIG. 4 shows the bed 10 with the actuator 20 and the user support structure 12 in both the user rest position (shown at 40) and in the user reception/departure position (shown at 42). Instead of having a pivotal movement about a fixed pivot axis A as the coupling mechanism 22, the user support structure 12 can be supported on the frame 18 by some other structure as the coupling mechanism 22, such as by first and second links so as to form a 4-bar linkage with the user support structure 12 and the frame 18. Alternatively any other type of movement and support can be provided.

While one or more electric motors 26 have been described as moving the user support structure 12 between the user rest 40 and the user reception/departure 42 positions, any other suitable type of actuator could be used, such as, for example a compressor with a pneumatic cylinder.

Referring to FIG. 4, limit switches 33 (shown individually at 33a and 33b) can be provided to signal to a controller unit 34 when the user support structure 12 has reached the user rest 40 or user reception/departure 42 positions. A user control pad 36, (e.g. in the form of a remote control or a bed-mounted control pad) (FIG. 1) can be provided for the user to operate the user support structure 12. The user control pad 36 can include a single switch or can include more complex control capability, for example, so as to permit the user support structure 12 to be positioned in other intermediate positions, between the user rest 40 and user reception/departure 42 positions. Communication between the limit switches 33 and the controller unit 34 and between the control pad 36 (in embodiments wherein the control pad 36 is not in the form of a remote control) and the controller unit 34 can be wireless or can be via hard-wired connections. It is recognized that the control unit 34 can also be mounted adjacent to the bed 10 and thereby off frame 18 (e.g. on a wall or floor surface of the room in which the bed is positioned and then connected to the control pad 36, actuators 20 and/or switches 33 (and sensors 60) via wired and/or wireless connections.

The body support structure 14 has been shown as a single rigid structure, however, it is optionally possible to provide a body support structure 14 that is articulated so as to have two or three sections that pivot relative to each other by a suitable mechanism and actuator (not shown but which is known in the art of articulated bed manufacturing) to permit the user to raise their head and upper body, to raise their feet, and/or to permit other resting positions for the user.

Referring again to FIG. 4, the controller unit 34 is used to coordinate positioning of the user support structure 12 between the user rest position 40 (see FIG. 2a,2d) and user reception/departure position 42 (see FIG. 2b,2c). The controller unit 34 is powered by a power supply 50 (e.g. a battery or a wall outlet otherwise known as mains supply power), which supplies operating power to the control unit 34 and/or optionally to other control components such as but not limited to the actuator(s) 20, limit switches 33 and control pad 36. The control pad 36, for example, can provide a user interface for receiving input commands from a bed operator and for displaying operational state/feedback based on operation of the switches 33 and actuators 20. The controller unit 34 also includes an input/output interface 52 for coupling to the control pad 36, the limit switches 33, and the actuator(s) 20. As such, the control pad 36, the limit switches 33, and the actuator(s) 20 can be considered as peripheral devices 37 that connect to the controller unit 34, for example as wired connections and/or wireless connections. The controller unit 34 also has a processor 54 (e.g. CPU) that processes input signals from one or more of the peripherals 37, based on a set of operating instructions 56 (e.g. stored in a physical memory 58 such as RAM or some other non-volatile memory), and generates one or more output signals that are transmitted to the one or more of the peripherals 37 in order to affect subsequent operation of the one or more of the peripherals 37.

For example, the controller unit 34 receives input signals from the limit switches 33 and from the control pad 36, processes those input signals based on the operating instructions 56, and then provides output signal(s) to the actuator(s) 20 in order to control the position (and/or rate of movement) of the support structure 12 between the user rest position 40 and the user reception/departure position 42. For example, when the limit switches 33 indicate to the controller unit 34 that the support structure 12 is in the user rest position 40, receipt of a move command signal (input signal) from the control pad 36 would cause the controller unit 34 to generate an actuator activation signal (output signal), for receipt by the actuator(s) 20, to cause operation of actuator(s) 20 to move the support structure 12 towards the user reception/departure position 42. Once the limit switches 33 indicate to the controller unit 34 that the support structure 12 is in the user reception/departure position 42, the controller unit 34 would generate an actuator deactivation signal (output signal), for receipt by the actuator(s) 20, to cause operation of actuator(s) 20 to cease and thereby assist in retaining the support structure 12 in the user reception/departure position 42.

Alternatively, when the limit switches 33 indicate to the controller unit 34 that the support structure 12 is in the user reception/departure position 42, receipt of a move command signal (input signal) from the control pad 36 would cause the controller unit 34 to generate an actuator activation signal (output signal), for receipt by the actuator(s) 20, to cause operation of actuator(s) 20 to move the support structure 12 towards the user rest position 40. Once the limit switches 33 indicate to the controller unit 34 that the support structure 12 is in the user rest position 40, the controller unit 34 would generate an actuator deactivation signal (output signal), for receipt by the actuator(s) 20, to cause operation of actuator(s) 20 to cease and thereby assist in retaining the support structure 12 in the user rest position 40. It is also recognised that when the support structure 12 is positioned between the user 40 and reception/departure 42 positions, as indicated by the limit switches 33, the controller unit 34 could initiate and/or continue to send the actuator activation signal (output signal), for receipt by the actuator(s) 20, to cause the actuator(s) 20 to move the support structure 12 towards a desired position or away from an undesired position. The actuator activation signal can be based on input signal(s) received from the control pad 36, as selected by the control pad 36 operator.

A further embodiment is where sensors 60 (e.g. pressure sensors, contact switches, etc.) provide an indication (e.g. input signal) to the controller unit 34 that the bed user is resting/standing on foot support member 16 and/or on body support member 14. For example, motion of the support structure 12 away from the user reception/departure position 42 could be dependent upon the controller unit 34 receiving indications from the sensors 60 that the bed user is both standing on the foot support member 16 and leaning on the body support member 14, before allowing actuator 20 operation to move the support structure 12 away from the user reception/departure position 42. Use of the sensors 60 can facilitate movement of the support structure 12 only when the bed user is in the proper position to handle such movement without adversely affecting the balance of the bed user. As such, sensing by the sensors 60 of at least a predefined portion of the user's weight could provide feedback to the controller unit 34 that the user is in proper contact with the sensor 60 on the foot support member 16 (e.g. the user is standing on it) and/or the user is in proper contact with the sensor 60 on the body support member 16 (e.g. the user is resting or otherwise leaning against it).

Examples of the controller unit 34 can be a Programmable Logic Controller (PLC), Programmable Logic Relays (PLR)s, or other computer devices (e.g. desktop computer) as is known in the art. As such, the controller unit 34 can be regarded as a digital computer used for automation of electromechanical processes associated with operation of the peripheral devices 37. As such, the controller unit 34 can be programmed by the operating instructions 56 to read limit switches 33 and/or sensors 60 for process variables (analog such as position, pressure), and operate actuators 20 such as electric motors 26 and other actuator devices such as pneumatic, hydraulic cylinders, magnetic relays, solenoids, or generic analog outputs by example. The input/output arrangements of the controller unit 34 can be built into a I/O arrangement or can have external I/O modules attached to a computer network (not shown) that plugs into the controller unit 34.

As such, the controller unit 34 is an example of a hard real time system since output signals are produced in response to input signals within a predefined limited time, otherwise unintended operation of the support structure 12 can result. In terms of input/output signals, examples are discrete signals and analog signals. Discrete signals can behave as binary switches, yielding simply an On or Off signal (1 or 0, True or False, respectively). Push buttons, Limit switches, and photoelectric (proximity) sensors are examples of peripheral devices 37 providing a discrete signal. Discrete signals can be sent using either voltage or current, where a specific range is designated as On and another as Off. For example, the controller unit 34 can use 24 V DC I/O, with values above 22 V DC representing On, values below 2VDC representing Off, and intermediate values undefined. Analog signals can be like volume controls, with a range of values between zero and full-scale. Analog signals are typically interpreted as integer values (counts) by the controller unit 34, with various ranges of accuracy depending on the device and the number of bits available to store the data. For example, pressure and weight can be represented by analog signals. Analog signals can use voltage or current with a magnitude proportional to the value of the process signal.

While the above description constitutes a plurality of embodiments of the present invention, it will be appreciated that the present invention is susceptible to further modification and change without departing from the fair meaning of the accompanying claims.

1. A bed, comprising:
a user support structure including a body support member having a head region and a foot region, and a foot support member positioned proximate the foot region of the body support member and projecting laterally from the body support member;
a frame for supporting the user support structure on a support surface;
a coupling mechanism coupling the user support structure to the frame and providing for relative movement there-between; and
an actuator that is configured to move the user support structure relative to the frame between a user rest position and a user reception/departure position, such that when in the user rest position the body support member is oriented to support the body of a user lying at least indirectly thereon, and when in the user reception/departure position, the body support member is oriented laterally to the foot support member such that the foot support member is oriented to support the user standing thereon.

2. The bed as claimed in claim 1, wherein the actuator is mounted to the frame.

3. The bed as claimed in claim 1, further comprising a mattress that is supported at least indirectly on the body support member.

4. The bed as claimed in claim 1, wherein the actuator includes at least one electric motor.

5. The bed as claimed in claim 1, wherein the actuator includes a final output gear that is operatively connected to the user support structure, and a plurality of electric motors positioned about the periphery of the final output gear for driving rotation of the final output gear.

6. The bed as claimed in claim 5, wherein the actuator includes a crank arm that is pivotally connected at one end to the final output gear and is pivotally connected at another end to the user support structure.

7. The bed of claim 1, wherein a portion of a length of the user support structure extends from the coupling mechanism towards the support surface to facilitate positioning of the foot support member adjacent to the support surface.

8. The bed of claim 7, wherein support members of the frame adjacent to the coupling mechanism are positioned away from a proximal end of the user support structure having the foot support member, so as to provide for positioning of the foot support member adjacent to the support surface when the user support structure is positioned in the user reception/departure position.

9. The bed of claim 7, wherein the coupling mechanism includes a pivot axis.

10. The bed of claim 7, wherein the coupling mechanism is configured to orient the user support structure at a non-perpendicular angle with respect to the support surface when the user support structure is in the user reception/departure position, so as to provide for both the body support member and the foot support member to support a portion of the weight of the user.

11. The bed of claim 1, wherein the actuator includes an actuation mechanism to provide for power assisted movement of the user support structure.

12. The bed of claim 1, wherein the actuator is configured to provide for retention of the user support structure when in the user rest position, the user reception/departure position, or temporarily when between the user rest position and the user reception/departure position.

13. The bed of claim 12, wherein the actuator includes at least one motor and one gear such that the at least one motor can drive the at least one gear but the at least one motor cannot be back-driven by the at least one gear.

14. The bed of claim 1 further comprising a controller unit configured for coordinating operation of the actuator based on input provided by at least one sensor or at least one switch.

15. The bed of claim 14 further comprising the controller unit configured for receiving input from a control pad for directing the position of the user support structure with respect to the user rest position and the user reception/departure position.

16. The bed of claim 14 further including at least one limit switch for providing operational state feedback to the controller unit based on position of the body support member relative to the user rest position or the user reception/departure position.

17. The bed of claim 14 further including the at least one sensor configured to provide an indication to the controller unit that the user is standing on the foot support member 16 or is resting on the body support member.

18. The bed of claim 14 further including the at least one sensor configured to provide an indication to the controller unit that the user is standing on the foot support member 16 and is resting on the body support member.

19. The bed of claim 14, wherein the at least one sensor is a pressure sensor or a contact switches.

20. The bed of claim 14, wherein controller unit is selected from the group consisting of: a Programmable Logic Controller (PLC) and a Programmable Logic Relays (PLR).
